(19) United States
(12) Patent Application Publication
(10) Pub. No.: US 2021/0284513 A1
(43) Pub. Date: Sep. 16, 2021

(54) System and Method of Managing a Lift Accident

(71) Applicant: Kile Stephen Nuehring, Cashmere, WA (US)

(72) Inventor: Kile Stephen Nuehring, Cashmere, WA (US)

(21) Appl. No.: 17/200,601

(22) Filed: Mar. 12, 2021

Related U.S. Application Data
(60) Provisional application No. 62/988,829, filed on Mar. 12, 2020.

(51) Int. Cl. B66F 17/00; B66F 11/04

(52) U.S. Cl. CPC B66F 17/006; B66F 11/042; B66F 11/046

(57) ABSTRACT

A system and method of managing a lift accident stops the operations of a man lift in the event a lift operator has fallen or in a dangerous position with the man lift. The system includes a man lift, a safety coupler, a lanyard, and a base coupler. The safety coupler and the base coupler establishes a safe position for a lift operator. The method begins by engaging the safety coupler to the base coupler, while attaching the second end to a lift operator within the lift platform. A set of positioning instructions for the lift platform is received with the lift mechanism. The set of positioning instructions is executed for the lift platform with the lift mechanism, if the safety coupler is engaged to the base coupler. The lift platform is locked in place with the lift mechanism, if the safety coupler is disengaged from the base coupler.

The current application claims a priority to the U.S. provisional patent application Ser. No. 62/988,829 filed on Mar. 12, 2020.

### FIELD OF THE INVENTION

The present invention generally relates to safety systems for heavy machinery. More specifically, the present invention is a system and method of managing a lift accident.

### BACKGROUND OF THE INVENTION

On an elevated work platform machine (boom or scissor lift) there is a series engineered “tie-off points” to connect the hook end of a lanyard. A lift operator gets into the machine and begins to operate the machine by going forward, reverse, side to side or vertically with or without adhering to OSHA standard of utilizing a fall protection harness and lanyard. The lanyard connects to the tie off points and the operator is secured and safe for operation. However, an operator could unsecure the lanyard hook from the tie off point while elevated at a great height, putting the operator at greater risk.

It is therefore an objective of the present invention to establish and determine a safe environment for a lift operator within a man lift. The present invention prevents a lift operator from using the man lift unless the lift operator is safely strapped with a lift platform of the man lift. The present invention, however, does not limit the range of motion of the lift operator within the lift platform. Rather, the present invention notifies the lift operator and individuals safely positioned on the ground around the man lift that lift operator is in an unsafe situation. The present invention prevents a lift operator from continuing any task until the lift operator has established a safe connection with the lift platform.

### BRIEF DESCRIPTION OF THE DRAWINGS

FIG. 1 is a diagram illustrating the system of the present invention.

FIG. 2 is a schematic diagram illustrating the electronic connections of the present invention.

FIG. 3 is a flowchart illustrating the overall process for the method of the present invention.

FIG. 4 is a flowchart illustrating the subprocess of stopping the operations for a lift platform if a safety coupler is disengaged from a base coupler of the present invention.

FIG. 5 is a flowchart illustrating the subprocess of emitting a red-colored light with a visual notification device until the safety coupler is engaged from the base coupler of the present invention.

FIG. 6 is a flowchart illustrating the subprocess of emitting a red-colored light with a visual notification device once the safety coupler is disengaged from the base coupler of the present invention.

FIG. 7 is a flowchart illustrating the subprocess of emitting a green-colored light with a visual notification device while the safety coupler is engaged from the base coupler of the present invention.

FIG. 8 is a flowchart illustrating the subprocess of emitting an alerting horn with an auditory notification device once the safety coupler is disengaged from the base coupler of the present invention.

FIG. 9 is a flowchart illustrating the subprocess of magnetically engaging the safety coupler with the base coupler of the present invention.

FIG. 10 is a flowchart illustrating the subprocess of electrically connecting and disconnecting a power supply with a lift mechanism in correspondence with the engagement and disengagement of the safety coupler with the base coupler of the present invention.

### DETAIL DESCRIPTIONS OF THE INVENTION

All illustrations of the drawings are for the purpose of describing selected versions of the present invention and are not intended to limit the scope of the present invention.

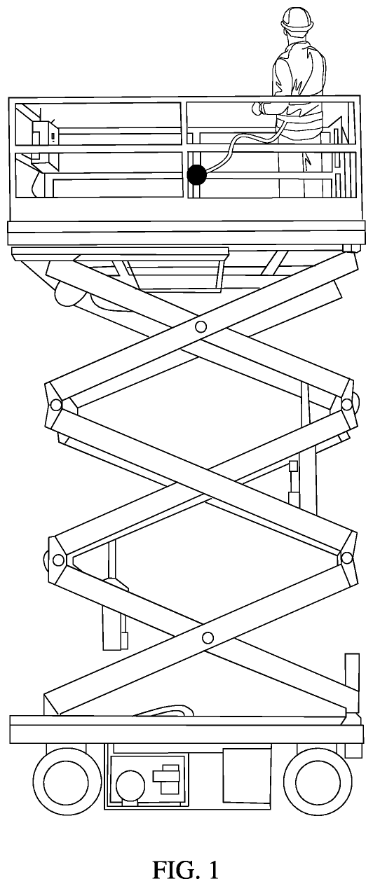

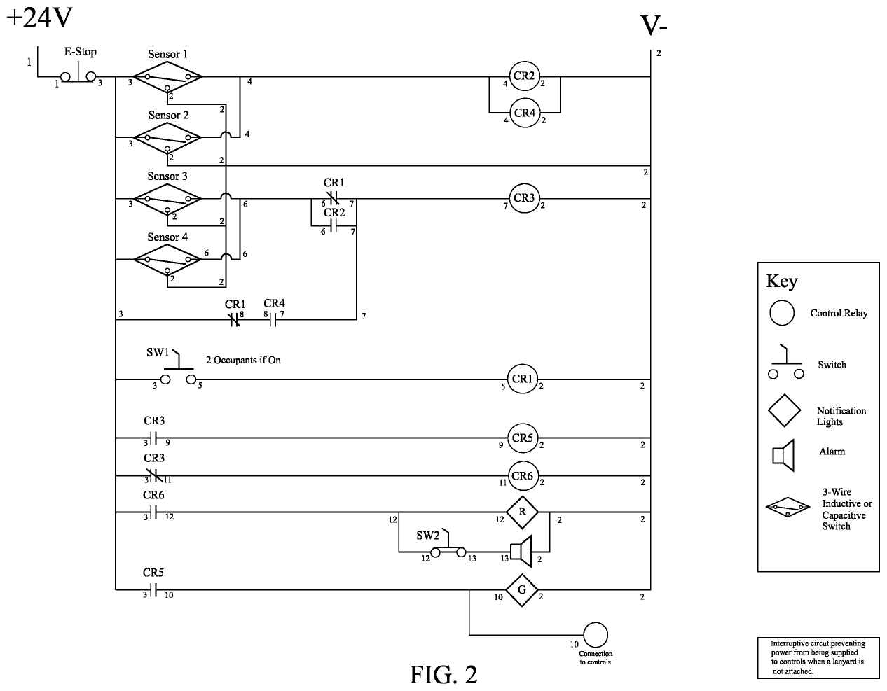

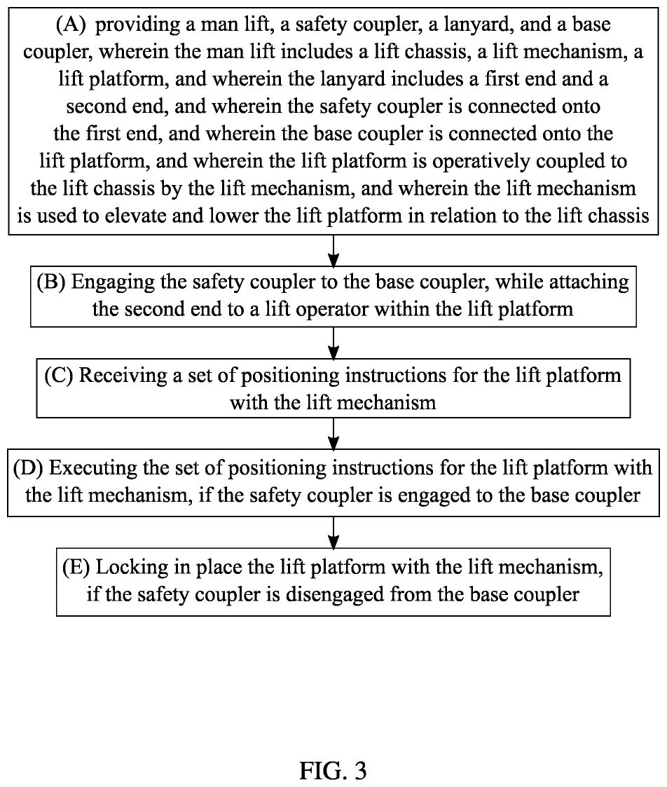

The present invention is a system and method of managing a lift accident. The present invention enhances and ensures the safety of a lift operator of a scissor lift, boom, lift, and the life. More specifically, the present invention removes human error from accidental injuries and fatal accidents due to improper tie-offs. Furthermore, the present invention automatically interrupts the power connection supplied to the platform of the lift once the safety of the lift operator is in question. Thus, the physical system used to implement the method for the present invention includes a man lift, a safety coupler, a lanyard, and a base coupler (Step A), seen in FIG. 1, FIG. 2, and FIG. 3. The man lift raises and lowers a lift operator to a desired location. In order to reach a desired location, the man lift includes a lift chassis, a lift mechanism, and a lift platform. The lift chassis upholds and moves the lift platform across the ground. The lift platform raises and lowers a lift operator from the ground with the lift platform. More specifically, the lift platform is operatively coupled to the lift chassis by the lift mechanism, and the lift mechanism is used to elevate and lower the lift platform in relation to the lift chassis. A lift operator is still able to freely move around the lift platform as the lanyard includes a first end and a second end. More specifically, the safety coupler is connected onto the first end, and the base coupler is connected onto the lift platform.

In order to determine the safety of a lift operator and provide an alert to the surrounding environment of an emergency, the overall process for the method of the present invention includes the following steps that are implemented with the man lift, the safety coupler, the lanyard, and the base coupler. The overall process begins by engaging the safety coupler to the base coupler, while attaching the second end to a lift operator within the lift platform (Step B), thereby establishing a connection between the safety coupler and the base coupler and a safe positioning of the lift operator, as seen in FIG. 3. The lift mechanism may then be managed by the lift operator as a set of positioning instructions for the lift platform is received with the lift mechanism (Step C). The set of positioning instructions remotely maneuvers the lift platform with the lift mechanism. The set of positioning instructions for the lift platform are executed with the lift mechanism, if the safety coupler is engaged to the base coupler (Step D), thereby ensuring the safety of the lift operator. Once the lift operator is in a dangerous or fatal situation, the lift platform is locked in place with the lift mechanism, if the safety coupler is disengaged from the base coupler (Step E).

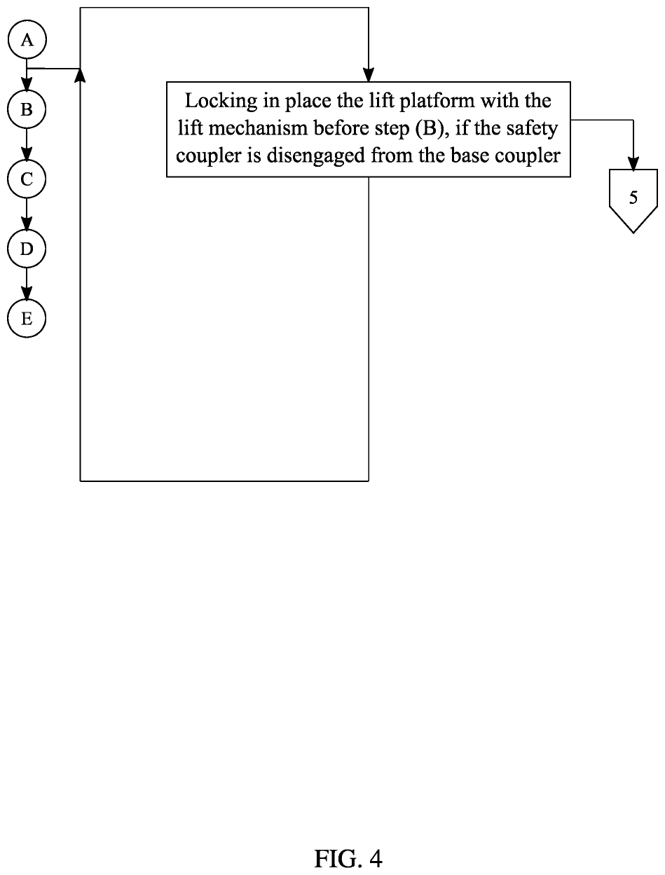

The present invention ensures the safety of the lift operator defines a safe environment for the lift platform as the lift platform is locked in place with the lift mechanism before Step B, if the safety coupler is disengaged from the base coupler, seen in FIG. 4. It is therefore essential the safety of the lift operator to be confirmed before any tasks are performed with the lift platform by connecting the safety coupler and the base coupler.

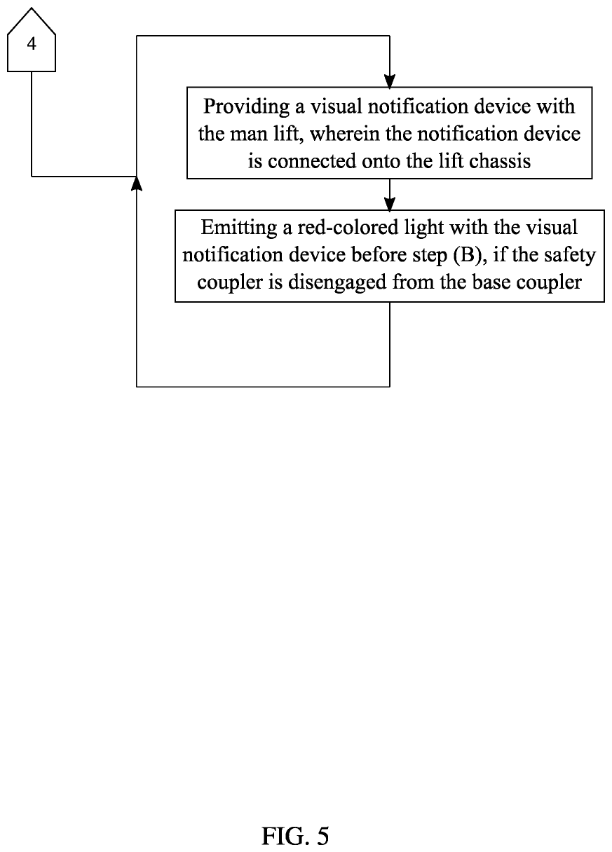

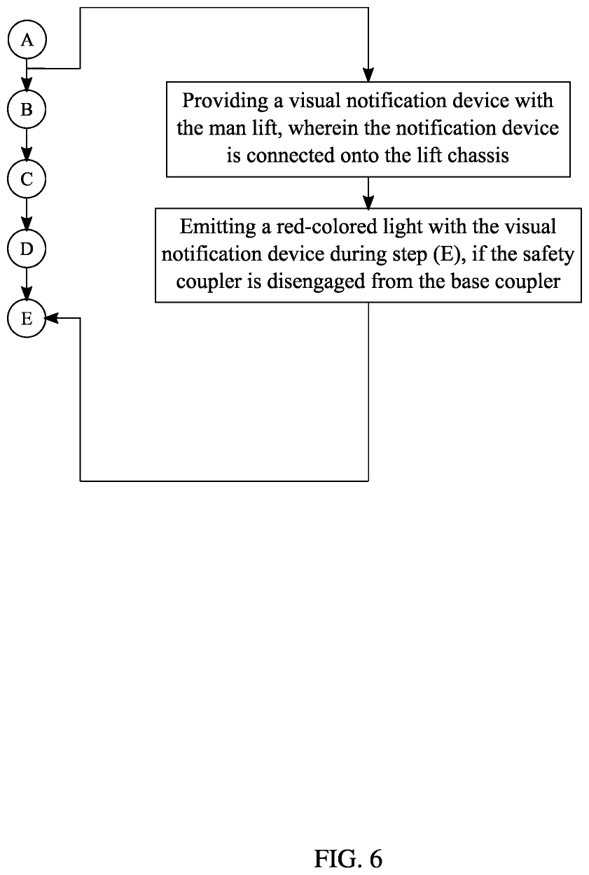

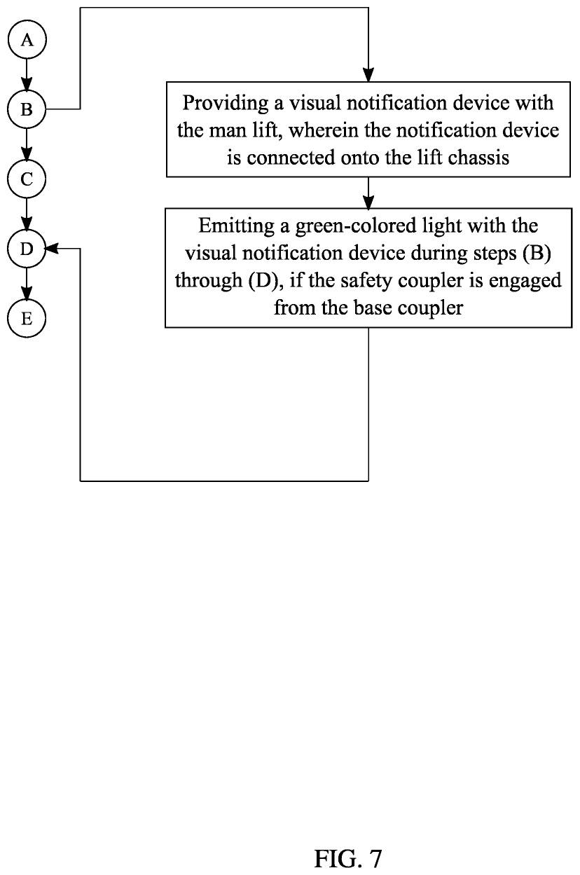

In order to alert individuals surrounding the man lift of an emergency with a lift operator, a visual notification is further provided with the man lift, wherein the notification device is connected onto the lift chassis so that the visual notification is readily seen by individuals on the ground, seen in FIG. 5. The visual notification is a light that visually communicated the status of a lift operator. Until a lift operator has connected the safety coupler with the base coupler and a safe environment within the lift platform has therefore been established, a red-colored light is emitted with the visual notification device before Step B, if the safety coupler is disengaged from the base coupler. Similarly, as seen in FIG. 6, an emergency is communicated to individuals surrounding the lift chassis as a red-colored light is emitted with the visual notification device during Step E, if the safety coupler is disengaged from the base coupler. Conversely, as seen in FIG. 7, a green-colored light is emitted with the visual notification device during Step B through Step D, if the safety coupler is engaged from the base coupler, thereby providing confirmation of the safety of the lift operator.

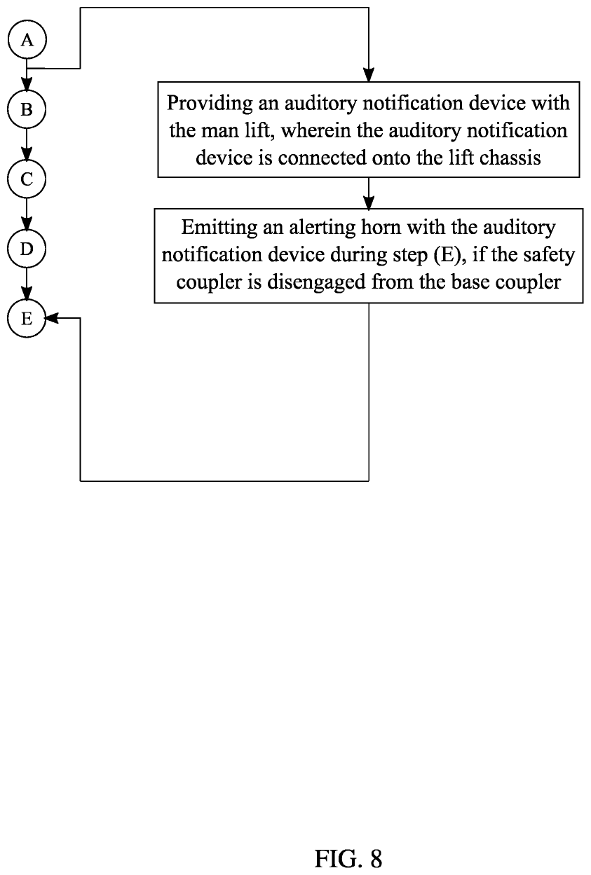

An emergency with the lift operator is further conveyed to the individuals around the lift chassis as an auditory notification device is provided with the man lift, wherein the auditory notification device is connected onto the lift chassis, seen in FIG. 8. The auditory notification is a sound that immediately alerts individuals around the lift chassis that may not be actively watching the visual notification. The emergency is audibly communicated as an alerting horn is emitted with the auditory notification device during Step E, if the safety coupler is disengaged from the base coupler. It is understood that various alarming sounds may be emitted with the auditory notification in order to alert individuals around the lift chassis.

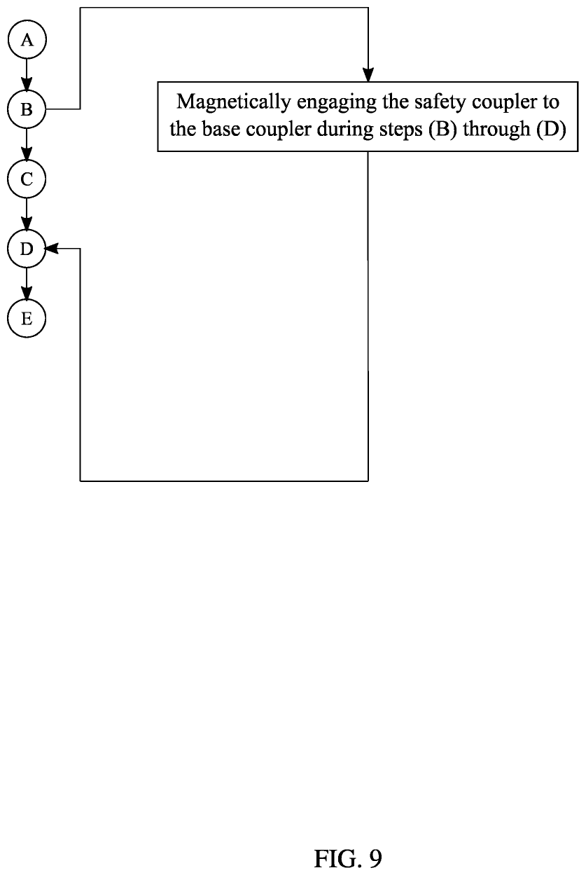

The connection between the safety coupler and the base coupler is facilitated as the safety coupler is magnetically engaged to the base coupler during Step B through Step D, seen in FIG. 9. The magnetic engagement also further reduces accidents and fatalities by allowing the disconnection between the safety coupler and the base coupler. More specifically, a lift operator is not surprisingly jerked by the lanyard while attempting to complete a task. Instead, a lift operator is notified of the unsafe position as well as the individuals around the lift chassis so that appropriate and safe adjustments may be made with the lift chassis itself.

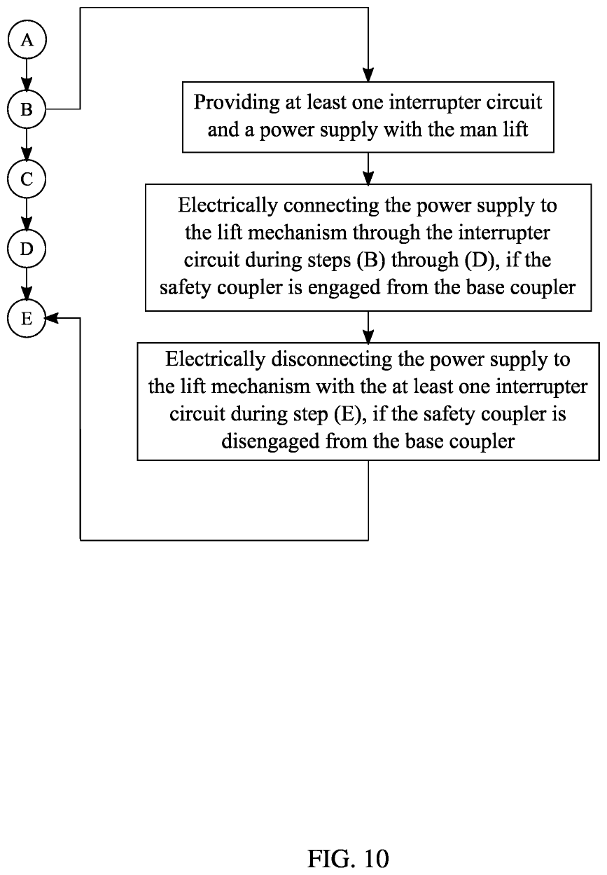

In order to permit and cease the operations of the lift platform, at least one interrupter circuit and a power supply are further provided with the man lift, seen in FIG. 10. At least one interrupter circuit controls the power connection between the power supply and the lift mechanism. The power supply is preferably a portable power source such as a battery that is integrated into the man lift and provides the necessary power for the lift mechanism to function. A lift operator is able to manage the positioning of the lift platform with the lift mechanism while in a safe position as the power supply is electrically connected to the lift mechanism through the interrupter circuit during Step B through Step D, if the safety coupler is engaged form the base coupler. Conversely, a lift operator is unable to operate the lift platform with the lift mechanism as the power supply is electrically disconnected to the lift mechanism with the at least one interrupter circuit during Step E, if the safety coupler is engaged from the base coupler.

Although the invention has been explained in relation to its preferred embodiment, it is to be understood that many other possible modifications and variations can be made without departing from the spirit and scope of the invention as hereinafter claimed.

What is claimed is:

1. A method of managing a lift accident, the method comprises the steps of:
(A) providing a man lift, a safety coupler, a lanyard, and a base coupler, wherein the man lift includes a lift chassis, a lift mechanism, a lift platform, and wherein the lanyard includes a first end and a second end, and wherein the safety coupler is connected onto the first end, and wherein the base coupler is connected onto the lift platform, and wherein the lift platform is operatively coupled to the lift chassis by the lift mechanism, and wherein the lift mechanism is used to elevate and lower the lift platform in relation to the lift chassis;
(B) engaging the safety coupler to the base coupler, while attaching the second end to a lift operator within the lift platform;
(C) receiving a set of positioning instructions for the lift platform with the lift mechanism;
(D) executing the set of positioning instructions for the lift platform with the lift mechanism, if the safety coupler is engaged to the base coupler; and,
(E) locking in place the lift platform with the lift mechanism, if the safety coupler is disengaged from the base coupler.

2. The method of managing a lift accident, the method as claimed in claim 1 comprises the step of:
locking in place the lift platform with the lift mechanism before step (B), if the safety coupler is disengaged from the base coupler.

3. The method of managing a lift accident, the method as claimed in claim 2 comprises the steps of:
providing a visual notification device with the man lift, wherein the notification device is connected onto the lift chassis; and,
emitting a red-colored light with the visual notification device before step (B), if the safety coupler is disengaged from the base coupler.

4. The method of managing a lift accident, the method as claimed in claim 1 comprises the steps of:
providing a visual notification device with the man lift, wherein the notification device is connected onto the lift chassis; and,
emitting a red-colored light with the visual notification device during step (E), if the safety coupler is disengaged from the base coupler.

5. The method of managing a lift accident, the method as claimed in claim 1 comprises the steps of:
providing a visual notification device with the man lift, wherein the notification device is connected onto the lift chassis; and,
emitting a green-colored light with the visual notification device during steps (B) through (D), if the safety coupler is engaged from the base coupler.

6. The method of managing a lift accident, the method as claimed in claim 1 comprises the steps of:
providing an auditory notification device with the man lift, wherein the auditory notification device is connected onto the lift chassis; and,
emitting an alerting horn with the auditory notification device during step (E), if the safety coupler is disengaged from the base coupler.

7. The method of managing a lift accident, the method as claimed in claim 1 comprises the steps of:
magnetically engaging the safety coupler to the base coupler during steps (B) through (D).

8. The method of managing a lift accident, the method as claimed in claim 1 comprises the steps of:
providing at least one interrupter circuit and a power supply with the man lift;
electrically connecting the power supply to the lift mechanism through the interrupter circuit during steps (B) through (D), if the safety coupler is engaged from the base coupler; and,
electrically disconnecting the power supply to the lift mechanism with the at least one interrupter circuit during step (E), if the safety coupler is disengaged from the base coupler.
